(19) United States
(12) Patent Application Publication
(10) Pub. No.: US 2023/0127555 A1
(43) Pub. Date: Apr. 27, 2023

(54) GRADING APPARATUS AND METHOD BASED ON DIGITAL DATA

(71) Applicant: Viverie LLC, Redmond, WA (US)

(72) Inventors: Hsiang-Lin Huang, Kaohsiung City (TW); Rushin Liu, Kaohsiung City (TW)

(73) Assignee: Viverie LLC, Redmond, WA (US)

(21) Appl. No.: 17/972,561

(22) Filed: Oct. 24, 2022

(30) Foreign Application Priority Data
Oct. 25, 2021 (TW) 110139569

(51) Int. Cl. G06N 5/04; G06N 5/02; G06V 10/82; G06V 10/80

(52) U.S. Cl. CPC G06N 5/048; G06N 5/02; G06V 10/82; G06V 10/806

(57) ABSTRACT

A grading apparatus and a method based on digital data are provided. In the method, feature information of an image is obtained through a first model. Content of the image includes a real object, and the first model is trained based on a deep learning algorithm. A first inference result is determined according to a first feature in the feature information. The first feature is a region feature and is corresponding to objects, and the first inference result is one or more defects on the real object. A second inference result of a second feature in the feature information is determined through a second model based on a semantic algorithm. The second feature is related to locations, and the second inference result is related to context presented by the real object. The first and the second inference results are fused to obtain a grading result of the real object.

### CROSS-REFERENCE TO RELATED APPLICATION

This application claims the priority benefit of Taiwan application serial no. 110139569, filed on Oct. 25, 2021. The entirety of the above-mentioned patent application is hereby incorporated by reference herein and made a part of this specification.

### BACKGROUND

### Technical Field

The disclosure relates to an image processing technique, and in particular to a grading apparatus and a method based on digital data.

### Description of Related Art

Collectible cards, player cards, or trading cards may have different values in the market depending on the content and quality of their records. With the rapid development of technology related to machine learning, image recognition and analysis capabilities are maturing and the results are accurate, even for determining defects on these cards. For example, identifying creases, damage, or fingerprints on cards. However, the criterion of grading only on the basis of defects is still flawed.

### SUMMARY

Embodiments of the disclosure provide a grading apparatus and a method based on digital data to provide a more accurate and objective evaluation based on more characteristic evaluation scores.

The grading method based on digital data according to the embodiment of the disclosure includes (but is not limited to) the following steps. Feature information of an image is obtained through a first model. Content of the image includes a real object, and the first model is trained based on a deep learning algorithm. A first inference result is determined according to a first feature in the feature information. The first feature is a region feature, and the first inference result is one or more defects on the real object. A second inference result of a second feature in the feature information is determined through a second model based on a semantic algorithm. The second feature is relative to locations, and the second inference result is relative to context presented by the real object. The first inference result and the second inference result is fused to obtain a grading result of the real object.

The grading apparatus based on digital data according to the embodiments of the disclosure includes (but is not limited to) a memory and a processor. The memory is for storing code. The processor is coupled to the memory. The processor is configured to load and execute the code to obtain feature information of an image through a first model, to determine a first inference result according to a first feature in the feature information, to determine a second inference result of a second feature in the feature information through a second model based on a semantic algorithm, and to fuse the first inference result and the second inference result to obtain a grading result of a real object. Content of the image includes the real object, and the first model is trained based on a deep learning algorithm. The first feature is a region feature, and the first inference result is one or more defects on the real object. The second feature is relative to locations, and the second inference result is relative to context presented by the real object.

Based on the above, according to the grading apparatus and the method based on digital data of the embodiments of the disclosure, the defect and the context presented by the real object is determined based on the feature information obtained by the deep learning algorithm, and several inference results are considered to obtain the grading result. In this way, an accurate and objective evaluation may be provided.

To make the aforementioned more comprehensible, several accompanied with drawings are described in detail as follows.

### BRIEF DESCRIPTION OF THE DRAWING

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of components of a grading apparatus according to an embodiment of the disclosure.

FIG. 2 is a flowchart of a grading method according to an embodiment of the disclosure.

FIG. 3 is a flowchart of an overall grading method according to an embodiment of the disclosure.

FIG. 4 is a flow chart of data fusion according to an embodiment of the disclosure.

### DESCRIPTION OF THE EMBODIMENTS

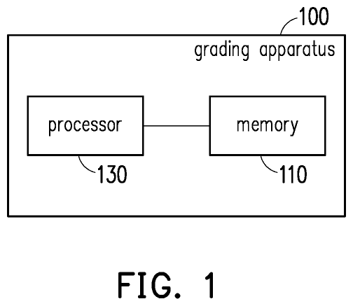

FIG. 1 is a block diagram of components of a grading apparatus 100 according to an embodiment of the disclosure. Referring to FIG. 1, the grading apparatus 100 includes (but is not limited to) a memory 110 and a processor 130. The grading apparatus 100 may be a desktop computer, a laptop computer, a smart phone, a tablet computer, a server, an optical inspection device, or other electronic devices.

The memory 110 may be any type of fixed or removable random access memory (RAM), read only memory (ROM), flash memory, hard disk drive (HDD), solid state drive (SSD), or similar components. According to one embodiment, the memory 110 is used to record code, software modules, configurations, data (e.g., training samples, model parameters, grading results, feature information, etc.) or other files, with embodiments to be described later.

The processor 130 is coupled to the memory 110. The processor 130 may be a central processing unit (CPU), a graphics processing unit (GPU), or other programmable general-purpose or special-purpose microprocessor, digital signal processor (DSP), programmable controller, field programmable gate array (FPGA), application specific integrated circuit (ASIC), neural network accelerator, or other similar components or a combination of the above components. According to one embodiment, the processor 130 is used to execute all or part of the operations of the grading apparatus 100, and may load and execute code, software modules, files, and data recorded in the memory 110.

In the following, the method described in the embodiments of the disclosure is described in conjunction with various devices, components and/or modules in the grading apparatus 100. The various processes of the method may be adapted to the circumstances of implementation and are not limited thereto.

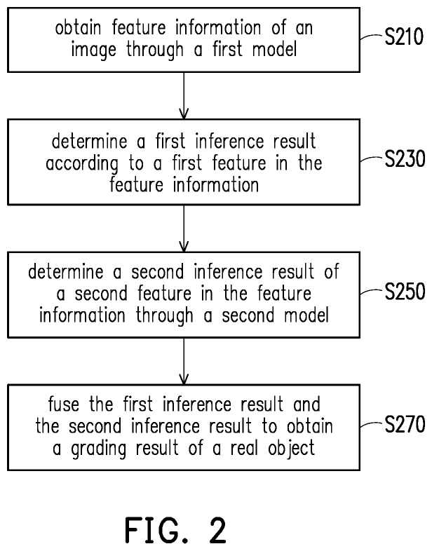

FIG. 2 is a flowchart of a grading method according to an embodiment of the disclosure. Referring to FIG. 2, the processor 130 obtains feature information of an image through a first model (step S210). Specifically, according to this embodiment, digital data is an image. Content of the image includes one or more real objects. According to one embodiment, the real object may be a collectible card, a trading card, a game card, or a player card. According to another embodiment, the real object may be any type of craft, painting, or other artwork. According to yet another embodiment, the real object may be an antique or any collectible. The grading apparatus 100 obtains an image of a real object taken by a camera or scanned by a scanner. The grading apparatus 100 may also obtain images through a network or an external storage device.

It should be noted that the first model is trained based on the deep learning algorithm. The deep learning algorithm may be a convolutional neural network, a transformer, other algorithms, or a combination thereof. Take the convolutional neural network as an example, this network includes one or more convolutional layers and fully connected layers at the top, which may also include association weights and pooling layers. The convolutional neural network or other learning algorithms may analyze training samples to obtain patterns from them, and thus predict unknown data by the patterns. The first model is used to obtain feature information of an input image.

The feature information includes one or more features. According to one embodiment, the feature in the feature information is a region feature. The region feature is, for example, a bounding box (or a region of interest (ROI)) for locations of one or more defects on a real object. The defect may be a stain, fingerprint, break, crease, or omission. Alternatively, the region feature may also be a bounding box of locations of one or more targets in context presented by the real object. The targets in the context presented by the real object may be a real or virtual character, vehicle, or other object.

According to another embodiment, the feature in the feature information is the location (or a grid location) of the region feature, i.e., the location of the bounding box in the real object, e.g., the stain is on the bottom side of the real object.

According to yet another embodiment, the features in the feature information are the locations and postures of one or more targets in the context presented by the real object. The target may be located at a specific location in the real object. For example, a player's head in a player card is positioned approximately in the middle of the card. The posture may be related to the orientation, movement, behavior, and/or appearance of the target, e.g., a basketball player shooting a basketball.

The processor 130 determines a first inference result according to a first feature in the feature information (step S230). Specifically, the first feature is a region feature, and the first inference result is one or more defects on the real object. The processor 130 may train the first model in advance based on the training samples of one or more types of defects, so that the first model may infer the types of the defects and their locations (i.e., region features).

The processor 130 determines a second inference result of a second feature in the feature information through a second model based on a semantic algorithm (step S250). Specifically, the second feature differs from the first feature in that the second feature is more location dependent, e.g., the location of the target or defect. Moreover, unlike the first inference result, the second inference result is relative to the context presented by the real object. For example, a player card presents the player's sports posture. For another example, a game card presents the attacking posture of a virtual character. The semantic algorithm is based on natural language and is used to analyze and understand explicit and implicit contexts in language. Optionally, the semantic algorithm can be used to analyze the textual language itself, as well as to analyze the context of an audio message, a photograph, or a continuous images/video, and then to select a set of questions according to the context. Thus, the semantic algorithm can be used to help determine the second inference result. The second model is a hybrid semantic algorithm such as Long Short-Term Memory (LSTM) model derived from natural language and Recurrent Neural Network (RNN).

It should be noted that natural language processing (NLP) can try to find out how computers interact with human language and further process and analyze large amounts of natural language data. In addition, natural language generation (NLG) is a subfield of NLP. NLG attempts to understand input sentences to generate a machine representation language and further convert the representation language into words. For example, the second model embeds words into a low-dimensional space and encodes the relationship between words, encodes word vectors into a vector considering context and semantics through techniques such as RNN, and places attention on important words.

According to one embodiment, the second model is trained based on a transformer network and is used for image caption or scene description, and the second feature is related to the location of the region feature. The transformer is, for example, a Dual-Level Collaborative Transformer (DLCT), GPT (Generative Pre-Training), BERT (Bidirectional Encoder Representation from Transformer) or other transformers. Image caption is also known as picture telling. The second model may generate words, sentences, or articles describing the context presented by the real object based on features obtained by the first model (e.g., the region feature and the grid location). The processor 130 may train the second model in advance based on the training samples from a network, a gallery, or a specific database that has been labeled with the presented context, such that the second model can describe the context presented by the real object in the image. For example, a player card showing a two-handed dunk by Player A in this year's playoffs.

According to another embodiment, the second model is trained based on a network of temporal and spatial dimensions and is used for behavior recognition, and the second feature is related to the locations and postures of one or more targets in the context presented by the real object. For example, a two-stream neural network architecture includes both time-streaming and spatial streaming networks. For the spatial part, each frame represents the surface information. For example, an object, its skeleton, a scene, etc. The time part refers to a movement of the object or its skeleton between several frames. For example, the movement of a camera or the movement information of a target. The processor 130 may train the second model in advance based on the video or animation so that the second model may describe behavior of the target as presented by the real object in the image. It should be noted that although the context presented by the real object may occur at certain point in time and no change in its context is known, the second model can be used to infer the events that occurred at the target or scene at that point in time.

According to some embodiments, the second model may also be trained based on more or different dimensional neural networks, and the disclosure is not limited thereto.

According to yet another embodiment, the processor 130 may determine a third inference result of a third feature in the feature information through a third model. According to this embodiment, the second model is related to the transformer for image caption and the third model is related to a multi-dimensional neural network for behavior recognition. For example, networks with temporal and spatial dimensions. The third inference result is also related to the context presented by the real object, and moreover to the behavior of the target in the context presented by the real object. Furthermore, the third feature is related to the location and pose of one or more targets in the context presented by the real object. These contexts may be referred to in the above description, and will not be repeated in the following.

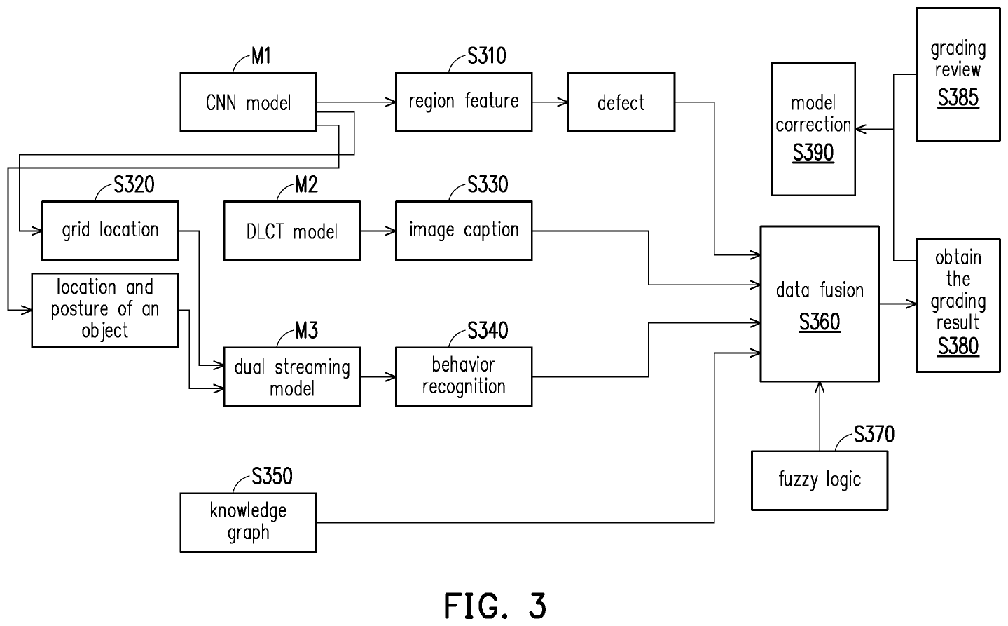

For example, FIG. 3 is a flowchart of an overall grading method according to an embodiment of the disclosure. Referring to FIG. 3, the processor 130 can use a CNN model M1 to obtain the region feature (step S310), and obtain the type of defect on the region. The processor 130 may use a DLCT model M2 and describe the context presented by the real object in the image based on the region feature and the grid location obtained by the CNN model M1 (step S330). Further, the processor 130 may identify the behavior of the target as presented by the real object (step S340) using a dual streaming model M3 and based on a full spatial grid location and location and posture of the object (i.e., the target) derived from the CNN model M1 (step S320).

According to some embodiments, the processor 130 may also utilize other models to obtain more inference results.

Referring to FIG. 2, the processor 130 fuses the first inference result and the second inference result to obtain the grading result of the real object (step S270). Specifically, each inference result may be related to an individual grading result. For example, if there are too many defects, the grading result will be lower. For another example, if the year corresponding to the behavior is older, the grading result will be higher. Therefore, these inference results need to be further integrated to get a final grading result. According to one embodiment, if there is a third inference result, the processor 130 may fuse the first inference result, the second inference result, and the third inference result. According to other embodiments, if there are more inference results, the processor 130 may fuse two or more of these inference results.

It should be noted that the grading result may be numeric, alphabetic, textual, symbolic or coded. For example, the grading result is 1 to 10 points, A to F grade, or good or bad.

According to one embodiment, the processor 130 may input the first inference result, the second inference result, and/or the third inference result to a fourth model to obtain the grading result. This fourth model is trained based on the neural network. The neural network is, for example, a deep neural network (DNN), a support vector machine (SVM), a deep convolutional network, or other networks. The fourth model has learned the relationship between features such as defects, context, behavior and/or other features and grading results. It should be noted that in some application contexts, the behavior of the target or the scenario described by the context may reflect the style of the real object. For example, the style of a particular era. The era is related to the grading result of the real object. For example, an older era may result in a higher grade. For another example, if the rarity of a particular style is higher, the grading result may be higher.

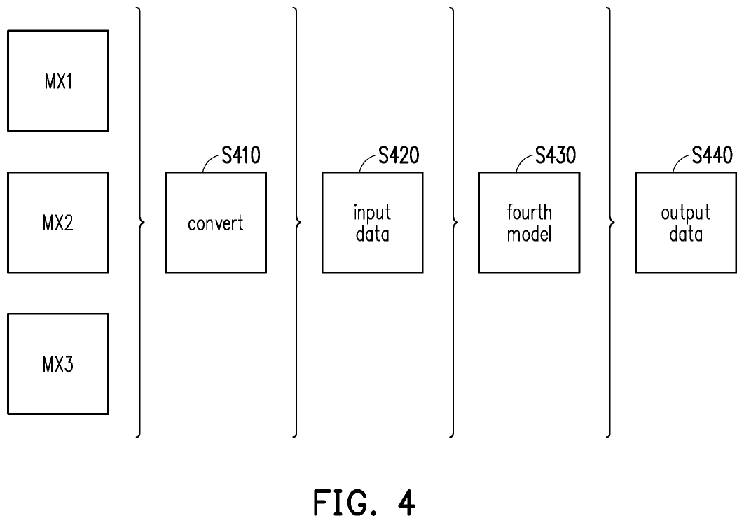

For example, FIG. 4 is a flow chart of data fusion according to an embodiment of the disclosure. Referring to FIG. 4, it is assumed that the three models output three inference results respectively (contexts are recorded in matrices MX1, MX2, and MX3 respectively). The processor 130 converts the matrices MX1, MX2, and MX3 into an input format suitable for the fourth model (step S410). The input format is, for example, related to the matrix size, the arrangement of the values, the specification of the values, and/or the type of the values. The processor 130 inputs data to the fourth model (step S420). That is, the data converted from the three matrices MX1, MX2, and MX3 are input into the fourth model. The processor 130 infers by the fourth model (step S430), and outputs data (i.e., the grading result) (step S440).

Referring to FIG. 3, according to one embodiment, the processor 130 may infer the grading result based on a knowledge graph (step S350). The knowledge graph includes relationships/associations between multiple entities. Entities are, for example, objects, events, situations, or abstract concepts. The processor 130 may determine how to describe the context or behavior presented by the real object based on the relationship between the target, its behavior, actions, and/or posture. For example, the processor 130 identifies multiple types of the targets through the first model and defines them separately as tokens, and then determines how to fill the tokens into sentences according to their relationship in the knowledge graph. Additionally, the knowledge graph may record the value of an entity or its scene at a specific point in time and help determine the grading result. For example, a particular dunk by a particular player in a particular year's dunk contest.

According to one embodiment, the processor 130 may infer the grading result through fuzzy logic (step S370). For example, the processor 130 may define the function or range of attribution of each of the inference result at different levels and set a fuzzy rule to infer the grading result.

According to one embodiment, the processor 130 performs data fusion on inference results from multiple models (step S360) to obtain the grading result (step S380). In addition, the processor 130 further obtains a result of a grading review (step S385). The grading review is, for example, the grading apparatus 100 receiving a manual grading result of the user input operation on the image. The processor 130 may correct the model based on the difference between an initial grading result and a reviewed grading result (step S390). For example, the processor 130 corrects the fourth model based on this difference.

To sum up, in the grading apparatus and the method based on digital data according to the embodiments of the disclosure, the inference results of multiple models are fused, and the grading result of the real object in the image is obtained accordingly. In this way, an accurate and objective evaluation may be provided.

It will be apparent to those skilled in the art that various modifications and variations can be made to the disclosed without departing from the scope or spirit of the disclosure. In view of the foregoing, it is intended that the disclosure covers modifications and variations provided that they fall within the scope of the following claims and their equivalents.

What is claimed is:

1. A grading method based on digital data, comprising:
obtaining feature information of an image through a first model, wherein content of the image comprises a real object, and the first model is trained based on a deep learning algorithm;
determining a first inference result according to a first feature in the feature information, wherein the first feature is a region feature, and the first inference result is at least one defect on the real object;
determining a second inference result of a second feature in the feature information through a second model based on a semantic algorithm, wherein the second feature is related to locations, and the second inference result is related to context presented by the real object; and
fusing the first inference result and the second inference result to obtain a grading result of the real object.

2. The grading method based on digital data according to claim 1, wherein the second model is trained based on a transformer network and used for image caption, and the second feature is related to a location of the region feature.

3. The grading method based on digital data according to claim 1, wherein the second model is trained based on a network of temporal and spatial dimensions and is used for behavior recognition, and the second feature is related to a location and posture of at least one target in the context presented by the real object.

4. The grading method based on digital data according to claim 2 further comprising:
determining a third inference result of a third feature in the feature information through a third model, wherein the third inference result is related to the context presented by the real object, the third model is trained based on a network of temporal and spatial dimensions and is used for behavior recognition, the third feature is related to a location and posture of at least one target in the context presented by the real object, and fusing the first inference result and the second inference result comprises:
fusing the first inference result, the second inference result, and the third inference result.

5. The grading method based on digital data according to claim 1, wherein fusing the first inference result and the second inference result comprises:
inputting the first inference result and the second inference result to a fourth model to obtain the grading result, wherein the fourth model is trained based on a neural network.

6. The grading method based on digital data according to claim 1, wherein fusing the first inference result and the second inference result comprises:
inferring the grading result through fuzzy logic.

7. The grading method based on digital data according to claim 1, wherein fusing the first inference result and the second inference result comprises:
inferring the grading result according to a knowledge graph, wherein the knowledge graph comprises relationships between a plurality of real objects.

8. The grading method based on digital data according to claim 1, wherein the real object is a collectible card, a trading card, a game card, or a player card.

9. A grading apparatus based on digital data, comprising:
a memory for storing code; and
a processor coupled to the memory and configured to load and execute the code to:
obtain feature information of an image through a first model, wherein content of the image comprises a real object, and the first model is trained based on a deep learning algorithm;
determine a first inference result according to a first feature in the feature information, wherein the first feature is a region feature, and the first inference result is at least one defect on the real object;
determine a second inference result of a second feature in the feature information through a second model based on a semantic algorithm, wherein the second feature is related to locations, and the second inference result is related to the context presented by the real object; and
fuse the first inference result and the second inference result to obtain a grading result of the real object.

10. The grading apparatus based on digital data according to claim 9, wherein the second model is trained based on a transformer network and used for image caption, and the second feature is related to a location of the region feature.

11. The grading apparatus based on digital data according to claim 9, wherein the second model is trained based on a network of temporal and spatial dimensions and is used for behavior recognition, and the second feature is related to a location and posture of at least one target in the context presented by the real object.

12. The grading apparatus based on digital data according to claim 10, wherein the processor is further configured to:
determine a third inference result of a third feature in the feature information through a third model, wherein the third inference result is related to the context presented by the real object, the third model is trained based on a network of temporal and spatial dimensions and is used for behavior recognition, the third feature is related to a location and posture of at least one target in the context presented by the real object; and
fuse the first inference result, the second inference result, and the third inference result.

13. The grading apparatus based on digital data according to claim 9, wherein the processor is further configured to:
input the first inference result and the second inference result to a fourth model to obtain the grading result, wherein the fourth model is trained based on a neural network.

14. The grading apparatus based on digital data according to claim 9, wherein the processor is further configured to:
infer the grading result through fuzzy logic.

15. The grading apparatus based on digital data according to claim 9, wherein the processor is further configured to:
infer the grading result according to a knowledge graph, wherein the knowledge graph comprises relationships between a plurality of real objects.

16. The grading apparatus based on digital data according to claim 9, wherein the real object is a collectible card, a trading card, a game card, or a player card.
